(19) United States
(12) Patent Application Publication
(10) Pub. No.: US 2016/0297565 A1
(43) Pub. Date: Oct. 13, 2016

(54) Stackable Check Presenter

(71) Applicant: Matthew Roszyk, The Woodlands, TX (US)

(72) Inventor: Matthew Roszyk, The Woodlands, TX (US)

(21) Appl. No.: 14/683,440

(22) Filed: Apr. 10, 2015

(51) Int. Cl. B65D 21/02; B65G 57/03; B65D 85/00; B65D 1/34; B65D 25/10

(52) U.S. Cl. CPC B65D 21/0209; B65D 1/34; B65D 25/10; B65D 85/70; B65G 57/03

(57) ABSTRACT

In one embodiment a stackable check presenter is constructed of a relatively flat material. A bill retaining means protrudes from the front surface of the stackable check presenter. A recess in the back surface of the stackable check presenter aligns with and contains the bill retaining means of an upper stackable check presenter when stacked up on a lower stackable check presenter. A slot along a side of the stackable check presenter allows a writing instrument to be retained by the stackable check presenter without extending beyond the front or back surface of the stackable check presenter. Standoffs, typically on the back surface of the stackable check presenter allow the stackable check presenter to be placed upon the surface without placing the stackable check presenter in debris that may be present. The standoffs also tend to prevent damage between an upper stackable check presenter and a lower stackable check presenter when stacked, one upon the other. A thin slot along a side or edge of the stackable check presenter allows the payment means, such as a credit card, to be used as a flag alerting the server that the check and payment are ready for processing.

### BACKGROUND

In many restaurants after dinner it is customary for the bill to be presented to the patron by the server. In most instances the bill is enclosed in a booklet and is placed on the table. Sometimes when the booklet is placed on the table it may be placed on top of accumulated water, spilled drinks, dropped food, or other debris. The patron may then inspect the bill and, provided the patron agrees with the charges, places a credit card sometimes in the booklet with a portion of the credit card protruding, sometimes entirely within the booklet, and sometimes on top of the booklet so that the server may take both the bill and the credit card in order to process the charges against the credit card.

Before the server returns to the table with the booklet, the server must find a pen to allow the patron to add a tip, total the bill, or sign the credit card charge. Usually the server will have multiple pens in the server's pocket or apron although in many cases the server must waste time searching for a pen.

Once the server has retrieved the booklet and signed credit card charge, the server must remove the pen from the booklet. In many instances the pen is not returned to its initial storage position and is left on a countertop where it is promptly misplaced. In the event that the pen is not removed from the booklet, the booklet cannot be completely closed preventing the booklet from being stacked or otherwise placed for easy retrieval for the next use. Even in those instances when the pen is removed from the booklet, the booklets rarely lay flat so that they can be stacked.

### SUMMARY

It is an object of the present invention to provide a check presenter that allows for multiple check presenters to be flatly stacked, one atop the other. It is a further object of the present invention to incorporate storage for writing instrument into the check presenter. Additional features may also include standoffs to allow the check presenter to be placed upon a table or other surface while preventing the check presenter from being placed directly into fluids or other debris that may be on the table or other surface. Also a slot may be incorporated to allow the credit card or other payment means to be used as a flag or signal to the server that the patron is ready for the server to take the check presenter and payment means in order to process the charges.

In one embodiment, in order to allow multiple check presenters to be flatly stacked, one atop the other, the check presenter has a recess cut into the bottom of the check presenter. The recess in turn, receives the bill retaining means that protrudes from the upper face of a lower check presenter thereby allowing the upper check presenter to remain flat, even in the presence of a protrusion from the upper face of the lower check presenter. Additionally it is preferred that the recess into the bottom of the check presenter is carried through to the upper edge of the check presenter thereby allowing the check presenter to be pulled straight out of the stack without catching a check presenter that may be under this check presenter being removed. In many instances the bill retaining means is simply a spring-loaded clip that is attached to the upper face of the check presenter by rivets, bolts, flare anchors, adhesives, or any other means known to attach a spring-loaded clip to a solid body. Additionally the spring-loaded clip may be replaced with a magnet where the magnet is embedded into the body of the check presenter and a piece of ferrous material that could be decorative itself or be encased in another decorative material used to secure the bill and/or payment means to the check presenter. It is foreseen that the ferrous material could be embedded into the body of the check presenter with the magnet being encased in decorative material or even two magnets one embedded in the check presenter with the second magnet being encased in decorative material to secure the bill and/or payment means.

In another embodiment, storage for a writing instrument is included. Such storage may include a recess along one of the edges of the check presenter. The recess provides space for the writing instrument to be retained by the check presenter while preventing the writing instrument from protruding, either below the bottom face, or above the top face of the check presenter. In many instances towards the lower end of the recess a port is formed into the check presenter such that the writing instrument may be inserted partially into the port with the remainder of the writing instrument residing in the recess. The writing instrument may be retained within the port by using a tapered writing instrument that may be wedged into the port, by forming the port with a conical taper so that the writing instrument may be wedged within the taper, or providing a friction enhancing device within the port such as a spring or an elastomer.

In certain instances the recess for the writing instrument may be formed such that it does not extend to a corner of the check presenter. By not allowing the recess to extend to a corner of the check presenter the overall strength of the check presenter is enhanced and the likelihood of cracking or breaking the portion of the check presenter retaining the writing instrument is reduced.

In other instances a port may be formed into the body of the check presenter that allows a writing instrument to be inserted into the port while allowing a portion of the writing instrument to extend out of the port and pass the edge of the check presenter so that the writing instrument may be retrieved from the check presenter in such an instance the recess for the writing instrument may not be desired. As before the writing instrument may be retained within the port by using a tapered writing instrument that may be wedged into the port, by forming the port with a conical taper so that the writing instrument may be wedged within the taper, or providing a friction enhancing device within the such as a spring or an elastomer.

In other embodiments, a thin slot may be added to the check presenter. Typically the slot is in the upper face off to one side, such that the credit card or other payment means may be inserted into the slot and extend vertically out of the face of the check presenter indicating to the server that the check presenter and payment are ready to be taken for processing. In some instances the slot may be added to the edge of the check presenter such that the credit card or other payment means extend horizontally out of the side of the check presenter.

In another embodiment, standoffs are preferably added to the lower face of the check presenter. The standoffs serve to elevate the lower face of the check presenter above the surface on which the check presenter is placed. Typically the standoffs are elastomeric buttons although metal pins, rails, or other materials may be used. Additionally the standoffs serve to elevate the lower face of an upper check presenter from directly contacting the upper face of an adjacent but lower check presenter upon which the upper check presenter is stacked, thereby preventing damage caused by stacking multiple check presenters, one upon the other.

### BRIEF DESCRIPTION OF THE DRAWINGS

FIG. 1 is a front view of an embodiment of a check presenter.

FIG. 2 is a side view of an embodiment of a check presenter.

FIG. 3 is a top view of an embodiment of a check presenter.

FIG. 4 is a front view of an alternative embodiment of a check presenter.

FIG. 5 is a side view of an alternative embodiment of a check presenter.

FIG. 6 is a top view of an alternative embodiment of a check presenter.

FIG. 7 is a front view of a second alternative embodiment of a check presenter.

FIG. 8 is a side view of a second alternative embodiment of a check presenter.

FIG. 9 is a top view of a second alternative embodiment of a check presenter.

### DETAILED DESCRIPTION

The description that follows includes exemplary apparatus, methods, techniques, or instruction sequences that embody techniques of the inventive subject matter. However, it is understood that the described embodiments may be practiced without these specific details.

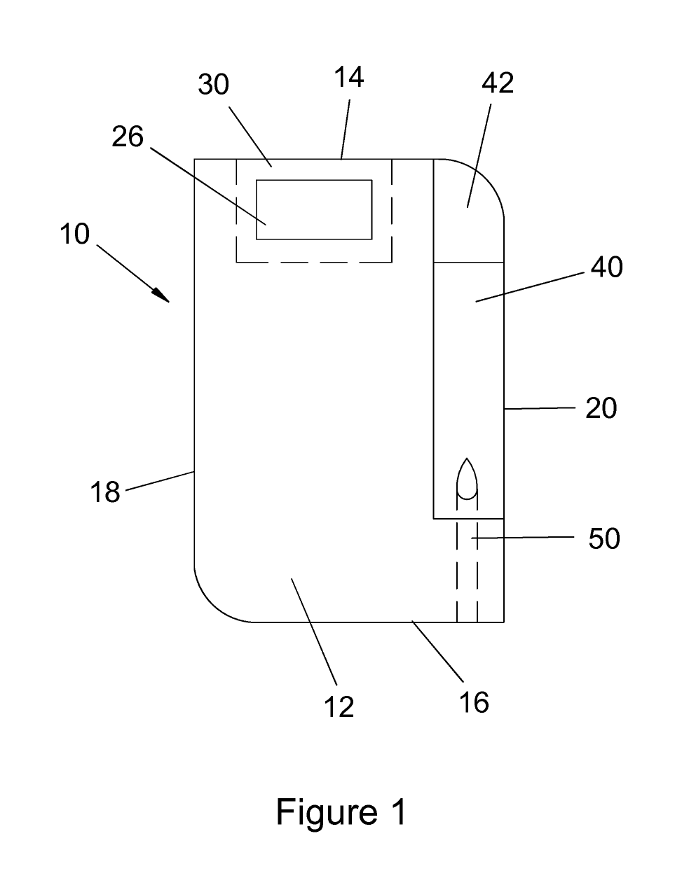

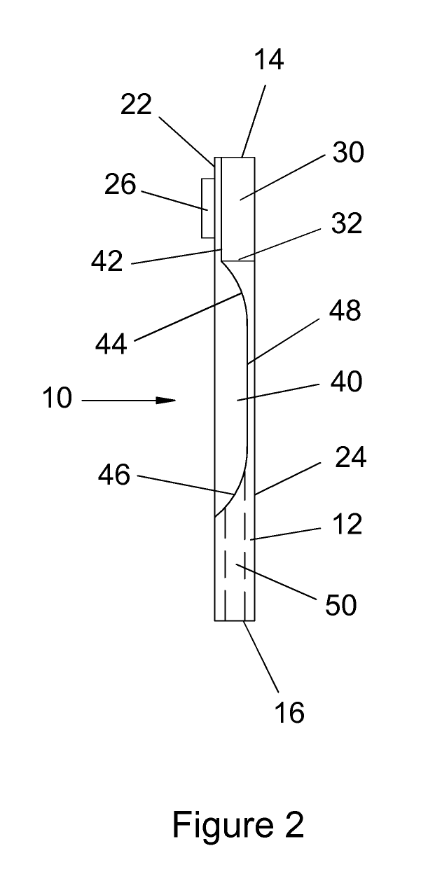

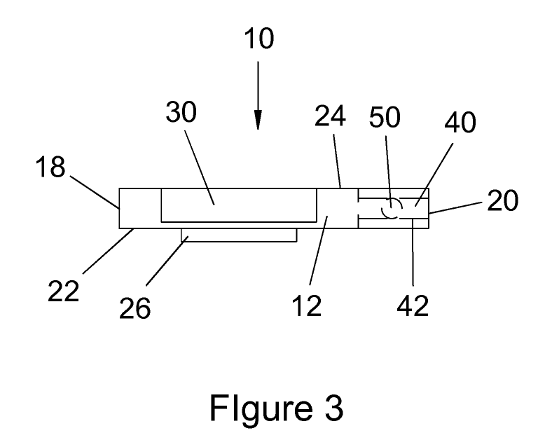

FIGS. 1-3 are front, side, and top views, respectively of an embodiment of a check presenter 10. The check presenter 10 has a main body 12. The main body 12 has a top or upper edge 14, a bottom or lower edge 16, a left edge 18, a right edge 20, a front face 22, and a back face 24. The check presenter 10 has on its front face 22 a clip 26. The clip 26 may be attached to the main body 12 by rivets, bolts, flare anchors, adhesives, or any other means known to attach a spring-loaded clip or other clip to the main body 12. On the back face 24 of the check presenter 10 is a recess 30. The recess 30 extends from lower shoulder 32 to the upper edge 14 of the check presenter. Additionally the recess 30 has a width that exceeds the width of the clip 26. The recess 30 is aligned such that when the left edge 18, the right edge is 22, the lower edge 16, and the upper edge 14 of the check presenter 10 are aligned with the left, right, lower, and upper edges of other similar check presenters (not shown) the clip 26 will be within the recess 30 thereby allowing multiple check presenters to be stacked flat, one atop the other without the protrusion of the clip 26 interfering. Additionally, by allowing the recess 30 to extend to the upper edge 14 of the check presenter 10, when multiple check presenters are stacked, one atop the other, the check presenter 10 may be either pulled directly off the top of the stack, sliding in the direction from the upper edge 14 to the lower edge 16, or directly off the bottom of the stack in the direction from the lower edge 16 to the upper edge 14.

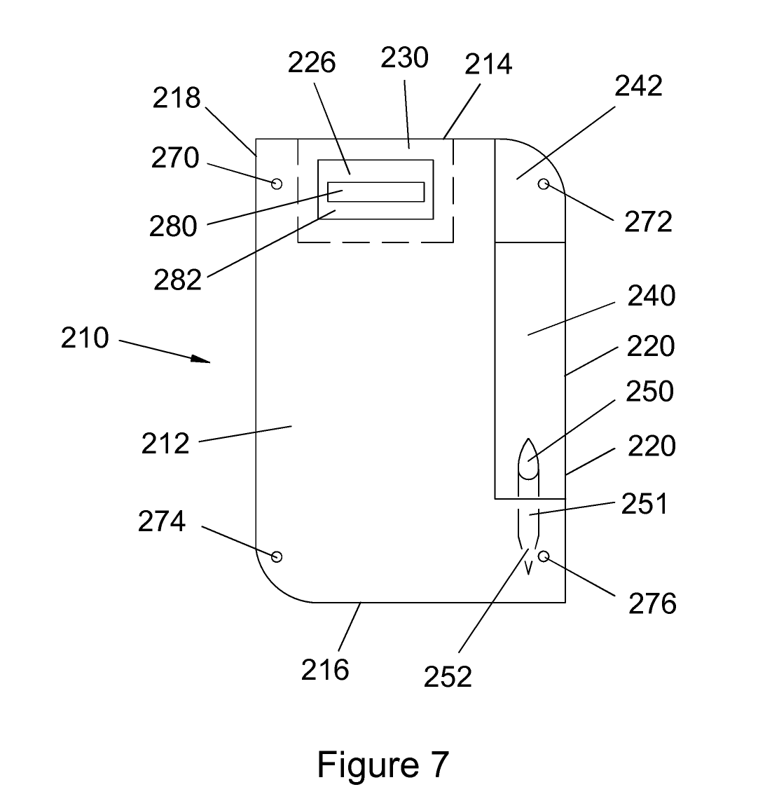

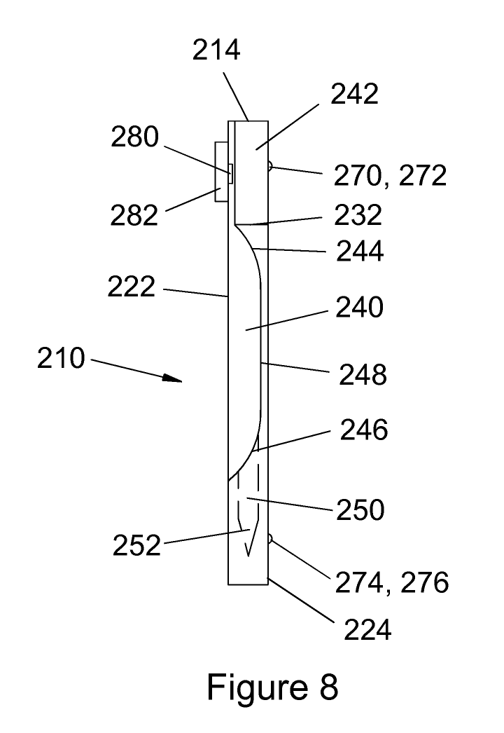

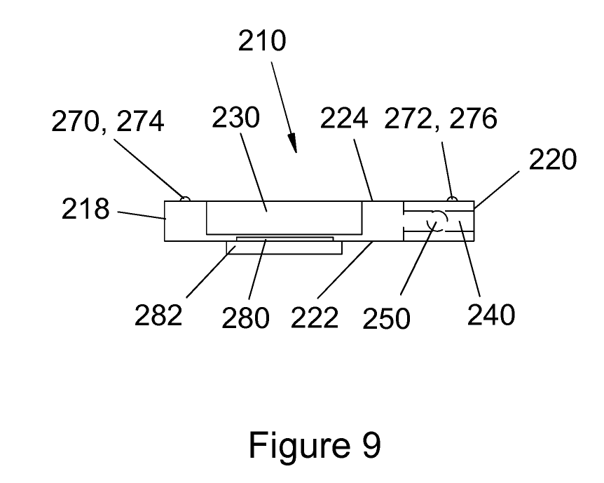

Along the right edge 20 a slot 40 has been formed in the body 12 of the check presenter 10 towards the upper edge 14 of the body 12. The slot 40 has a thicker portion 42. The thicker portion 42 has an upper taper 44 and a lower taper 46. Between the upper taper 44 and lower taper 46 is the main slot 48. In lower taper 46 is port 50. Port 50 is formed longitudinally through the interior of body 12. In this instance port 50 has a uniform diameter so that an end of a tapered writing instrument (not shown) may be placed into port 50 while the majority of the writing instrument resides within slot 40. In this instance it is desired that the writing instrument have a taper so that friction between the tapered portion of the writing instrument and the port 50 will hold the writing instrument in place within slot 40. In other instances port 50 may be tapered as shown in FIGS. 7-9. And in still other instances a friction enhancer such as a spring, elastomer, or other means may be placed within port 50 to hold a writing instrument in place within port 50.

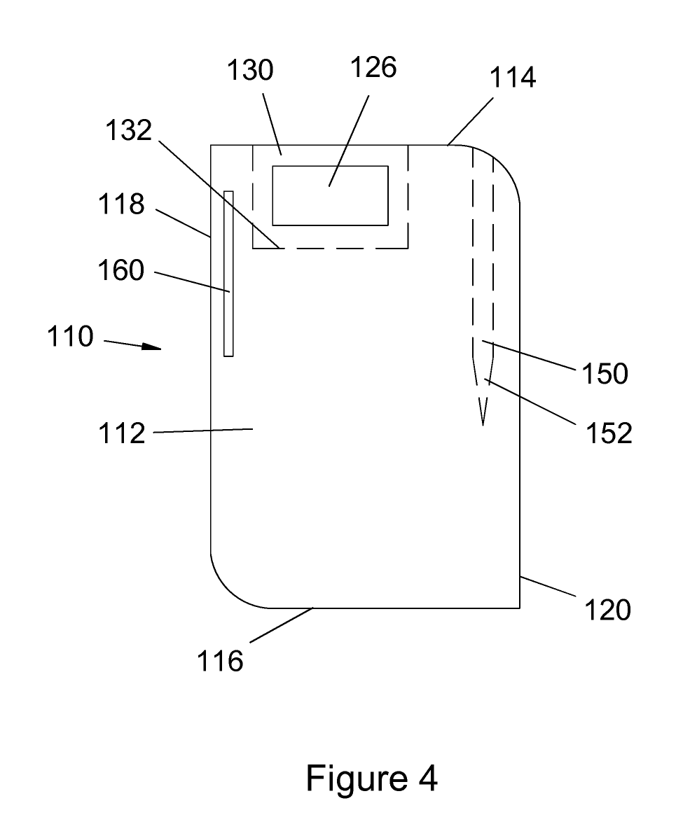

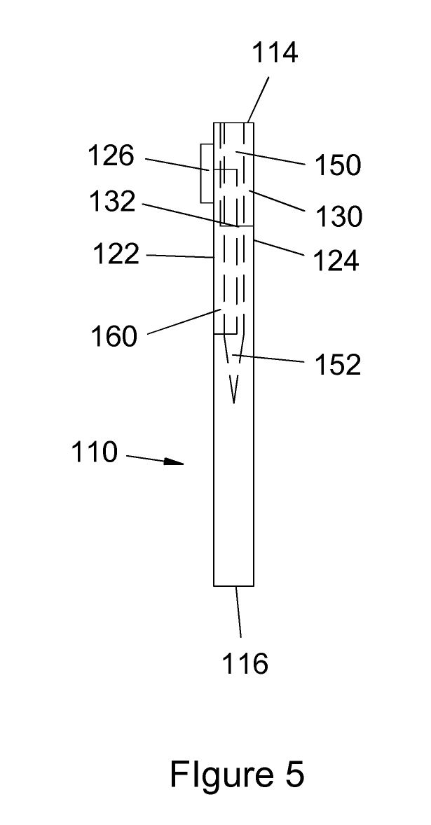

FIGS. 4-6 are front, side, and top views respectively of an alternative embodiment of a check presenter 110 having a payment flag slot 160 and without a slot for a writing instrument. The check presenter 110 has a main body 112. The main body 112 has a top or upper edge 114, a bottom or lower edge 116, a left edge 118, a right edge 120, a front face 122, and a back face 124. The check presenter 110 has on its front face 122 a clip 126. The clip 126 may be attached to the main body 112 by rivets, bolts, flare anchors, adhesives, or any other means known to attach a spring-loaded clip or other clip to the main body 112. On the back face 124 of the check presenter 110 is a recess 130. The recess 130 extends from lower shoulder 132 to the upper edge 114 of the check presenter. Additionally the recess 130 has a width that exceeds the width of the clip 126. The recess 130 is aligned such that when the left edge 118, the right edge is 120, the lower edge 116, and the upper edge 114 of the check presenter 110 are aligned with the left, right, lower, and upper edges of other similar check presenters (not shown) the clip 126 will be within the recess 130 thereby allowing multiple check presenters to be stacked flat, one atop the other without the protrusion of the clip 126 interfering. Additionally by allowing the recess 132 to extend to the upper edge 114 of the check presenter 110, when multiple check presenters are stacked, one atop the other, the check presenter 110 may be either pulled directly off the top of the stack, sliding in the direction from the upper edge 114 to the lower edge 116, or directly off the bottom of the stack in the direction from the lower edge 116 to the upper edge 114.

Along the right edge 120 a port 150 has been formed in the body 112 of the check presenter 110. The port 150 extends laterally into the body 112 of the check presenter 110 to a depth that is sufficient to enclose a writing utensil (not shown) with some portion of the writing utensil extending beyond the upper edge 114 to allow a server or patron to access the writing utensil. In the embodiment shown at the lower end of port 150 is a tapered portion 152. The tapered portion 152 allows the writing utensil to be wedged into the tapered portion 152 preventing the writing utensil from falling out of port 150 in the event the check presenter 110 is tipped at an unusual angle.

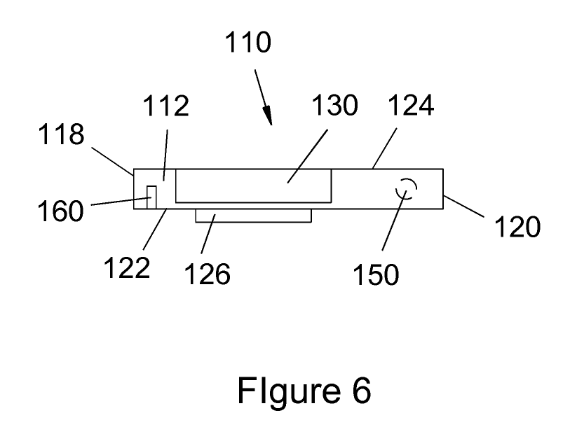

Along the left edge 118 a slot 160 is formed into the body 112 of the check presenter 110. The slot 160 extends from the front face 122 towards the back face 124 of the check presenter 110 a depth that is sufficient to prevent the payment means, such as a credit card, from tipping over. While the slot 160 is shown in FIG. 6 to extend vertically into the front face 122 it may be desired to angle the slot 160 some amount. Alternatively, the slot 160, rather than extending from face 122, may extend from left edge 118 into the body 112 towards right edge 122 a depth sufficient to retain the payment means while allowing the payment means to extend an amount to both allow easy access of the payment means and notify the server to pick up the check presenter 110.

FIGS. 7-9 are front, side, and top views, respectively of an alternative embodiment of a check presenter 210. The check presenter 210 has a main body 212. The main body 212 has a top or upper edge 214, a bottom or lower edge 216, a left edge 218, a right edge 220, a front face 222, and a back face 224. The check presenter 210 has on its front face 222 a clip 282. The clip 282 may be attached to the main body 212 by rivets, bolts, flare anchors, adhesives, or any other means known to attach a spring-loaded clip or other clip to the main body 212. On the back face 224 of the check presenter 210 is a recess 230. The recess 230 extends from lower shoulder 232 to the upper edge 214 of the check presenter. Additionally the recess 230 has a width that exceeds the width of the clip 226. The recess 230 is aligned such that when the left edge 218, the right edge 220, the lower edge 216, and the upper edge 214 of the check presenter 210 are aligned with the left, right, lower, and upper edges of other similar check presenters (not shown), the clip 282 will be within the recess 230 thereby allowing multiple check presenters to be stacked flat, one atop the other without the protrusion of the clip 226 interfering. Additionally by allowing the recess 230 to extend to the upper edge 214 of the check presenter 210, when multiple check presenters are stacked, one atop the other, the check presenter 210 may be either pulled directly off the top of the stack, sliding in the direction from the upper edge 214 to the lower edge 216, or directly off the bottom of the stack in the direction from the lower edge 216 to the upper edge 214.

At each of the corners on the bottom face 224 standoffs 270, 272, 274, and 276 are shown. The standoffs 270, 272, 274, and 276 serve to elevate the lower face 224 of the check presenter 210 above the surface on which the check presenter 210 is placed. Typically the standoffs 270, 272, 274, and 276 are elastomeric buttons although metal pins, rails, or other materials may be used. Additionally the standoffs 270, 272, 274, and 276 serve to elevate the lower face 224 of the check presenter from directly contacting the upper face of an adjacent but lower check presenter (not shown), upon which the check presenter 210 is stacked thereby preventing damage caused by stacking the check presenters, one upon the other.

The bill retaining means may be a magnet 282 where the magnet is embedded into a decorative material such as a material that matches the material of the body 212. A ferrous material 280 is embedded into the body 212 so that the magnet 282, when placed over the ferrous material 280, typically with the check and/or payment means sandwiched between the magnet and ferrous material, can retain the check and/or payment means in place on the check presenter 210. It is foreseen that the magnet could be embedded into the body of the check presenter with the ferrous material used as the upper portion of the retaining means either alone or being encased in decorative material.

Along the right edge 220 a slot 240 has been formed in the body 212 of the check presenter 210 towards the upper edge 214 of the body 212. The slot 240 has a thicker portion 242. The thicker portion 242 has an upper taper 244 and a lower taper 246. Between the upper taper 244 and lower taper 246 is the main slot 248. In the lower taper 246 is port 250. Port 250 is formed longitudinally through the interior of body 212. Port 250 has an upper portion 251 having a uniform diameter so that an end of a writing instrument (not shown) may be placed into port 250 while the majority of the writing instrument resides within slot 240. The port 250 also has a lower portion 252 that is tapered such that the writing instrument will lodge in the taper allowing friction between the taper in lower portion 252 of port 250 and the writing instrument, holding a writing instrument in place within slot 240. In other instances the port may not be bored through, as depicted in port 250, but may not have a taper. A friction enhancer such as a spring, elastomer or other means may be placed within port 250, either with or without a taper, to hold a writing instrument in place within port 250.

While the embodiments are described with reference to various implementations and exploitations, it will be understood that these embodiments are illustrative and that the scope of the inventive subject matter is not limited to them. Many variations, modifications, additions and improvements are possible.

Plural instances may be provided for components, operations or structures described herein as a single instance. In general, structures and functionality presented as separate components in the exemplary configurations may be implemented as a combined structure or component. Similarly, structures and functionality presented as a single component may be implemented as separate components. These and other variations, modifications, additions, and improvements may fall within the scope of the inventive subject matter.

What is claimed is:

1. A check presenter comprising:
a body,
a check retainer on an upper face of the body, a slot on a lower face of the body wherein the slot provides a recess to contain a second check retainer on a second body when the body is stacked upon the second body, and
a second slot providing a second recess for retaining a writing instrument between the upper face and the lower face of the body.

2. The check presenter of claim 1, further comprising a payment flag slot.

3. The check presenter of claim 2 wherein, the payment flag slot is in the upper face of the body.

4. The check presenter of claim 2 wherein, the payment flag slot is in a side of the body.

5. The check presenter of claim 1, further comprising a standoff on the lower face of the body.

6. The check presenter of claim 5 wherein, the standoff is an elastomer.

7. The check presenter of claim 5 wherein, the standoff is at least two rails.

8. The check presenter of claim 1 wherein, the slot extends to an edge of the body.

9. The check presenter of claim 1 wherein, the second slot includes a friction enhancer to fix the writing instrument in place within the second slot.

10. The check presenter of claim 1 wherein, the check retainer has a first ferrous portion and a second magnetic portion.

11. A method of stacking a check presenter comprising:
placing a first check presenter on a surface,
wherein the first check presenter has a body and a check retainer on an upper face of the body,
placing a second check presenter on the upper face of the first check presenter,
aligning the second check presenter,
wherein a second slot on a lower face of a second body of the second check presenter provides a second recess to contain the check retainer on the upper face of the first check presenter, and
placing a writing instrument within a third slot of the first check presenter,
wherein the third slot provides a recess for retaining a writing instrument between the upper face and the lower face of the check presenter.

12. The method of claim 11, further comprising inserting a payment into a payment flag slot.

13. The method of claim 12 wherein, the payment flag slot is in the upper face of the body.

14. The method of claim 12 wherein, the payment flag slot is in a side of the body.

15. The method of claim 11, further comprising placing a standoff between the first check presenter and the second check presenter.

16. The method of claim 15 wherein, the standoff is an elastomer.

17. The method of claim 15 wherein, the standoff is at least two rails.

18. The method of claim 11 wherein, the second slot extends to an edge of the second body.

19. The method of claim 11 wherein, the third slot includes a friction enhancer to fix the writing instrument in place within the third slot.

20. The method of claim 11 wherein, the check retainer has a first ferrous portion and a second magnetic portion.
